(19) United States
(12) Patent Application Publication
(10) Pub. No.: US 2007/0114960 A1
(43) Pub. Date: May 24, 2007

(54) Actuating device for a movable component

(75) Inventor: Jorg Hillen, Nortershausen (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/602,819

(22) Filed: Nov. 21, 2006

(30) Foreign Application Priority Data
Nov. 21, 2005 (DE) 10 2005 055 788.0

(51) Int. Cl. H02P 1/00

(52) U.S. Cl. 318/280

(57) ABSTRACT

An actuating device for a movable component includes a reversible motorized drive for driving the movable component from a normal position into an open position, the movable component being uncouplable from the reversible motorized drive in its open position. The actuating device includes a driving element movably drivable by the reversible motorized drive and engages in a crank recess and extending along the path of motion of the movable component. A length of the crank recess corresponds at least to a path of motion of the driving element between its normal position and its open position or partially open position. After adjustably driving the movable component into its open position, the driving element may be returned by the reversible motorized drive into the normal position.

### BACKGROUND OF THE INVENTION

1. Field of the Invention

The present invention relates to an actuating device with a motorized drive for driving a movable component from a normal position into an open position and a free wheel permitting uncoupling of the movable component from the motorized drive in the open position.

2. Description of the Related Art

In an actuating device for actuating a flap, it is known that when the motorized drive is switched off and the opened flap is manually closed, a driving pinion for motorized pivoting of the flap is uncoupled from the motorized drive by a free wheel. The free wheel may be configured as a free-wheeling hub or as a switchable coupling, which is arranged on the drive shaft of the motorized drive. This design of an actuating device is complex and costly.

### SUMMARY OF THE INVENTION

An object of the present invention is to provide an actuating device for actuating a movable component such as a flap with a simple construction of the movable component along with a motorized drive which allows manual actuation with little manual force.

The object is achieved in that a driving element is movably drivable by a reversible motorized drive and engages in a crank recess extending along the path of motion of the movable component, the length of the crank recess corresponding at least to the path of motion of the driving element between its normal position and its open position or partially open position. A switching device is operatively arranged so that after adjustably driving the movable component into its open position, the driving element may be returned by the motorized drive into the normal position.

The object is also achieved in that a crank component is movably drivable by the reversible motorized drive and comprises a crank recess extending along the path of motion of the movable component, into which a driving element arranged on the movable component engages, the length of the crank recess corresponding at least to the path of motion of the driving element between its normal position and its open position or partially open position. A switching device is operatively arranged so that after adjustably driving the movable component into its open position, the crank component may be returned by the motorized drive into the normal position.

In these embodiments, after motorized movement of the movable component into its open position, the driving element and/or the crank component is/are again returned in a motorized manner into its/their normal position. If the movable component is now to be moved manually from its open position into its normal position, the driving element is able to move freely and without resistance in the crank recess.

Furthermore, if the movable component is movably drivable by the reversible motorized drive by the driving element or the crank component from its open position into its normal position and, by the switching device, after adjustably driving the movable component into its normal position, the driving element or the crank component may be returned by the motorized drive into its normal position, the ability to move the movable component manually and substantially without resistance from its normal position into its open position is, therefore, also possible.

The switching device may simply comprise switching elements, which detect when the driving element has reached the end or ends of the crank recess.

A simple design for moving the movable component is for one or both ends of the crank recess to form stops against which the driving element may bear and, by moving the driving element or by moving the crank component, the movable component is movably drivable.

An emergency cut-out is achieved in that the stop or stops, when impinged upon by the driving element towards the end of the crank recess, are spring stops which may be deflected counter to a set spring force, the set spring force being greater than the force applied by the driving element when the driving element or the crank component is driven by the motorized drive. When the spring stops are deflected by the driving element, either a switch generating a switch signal is actuated or an increased power consumption of the motor is identified. The motorized drive is able to be switched off in response to the switch signal or the increased power consumption of the motor.

Thus, normal motorized driving of the movable component does not result in compression of the spring stops by the driving element. In the case of misuse, if the motorized drive is manually engaged on the movable component counter to the drive direction, the spring stop is deflected by the set spring force being overcome and the switch actuated so that the motorized drive is switched off. Thus, the motorized drive is protected against damage.

Alternatively, however, an overload clutch, such as for example a slip clutch may be arranged in the drive train between the motorized drive and the movable component.

The motorized drive may be a linear drive or a rotary drive. For force transmission, the driving element or the crank component may preferably be driven by the motorized drive via a gear mechanism. The motorized drive may be a pneumatic drive or a hydraulic drive. Preferably, however, the motorized drive is an electromotor. The movable component may, for example, be held by a latching device in its open position.

If force is able to be applied to the movable component by a spring in the direction of motion from the normal position into the open position, the spring preferably being a pneumatic spring, this results not only in retaining the movable component in the open position but also in supporting the motorized drive during movement of the manually lowered and then raised, the driving element 14 moving freely in the crank recess 13.

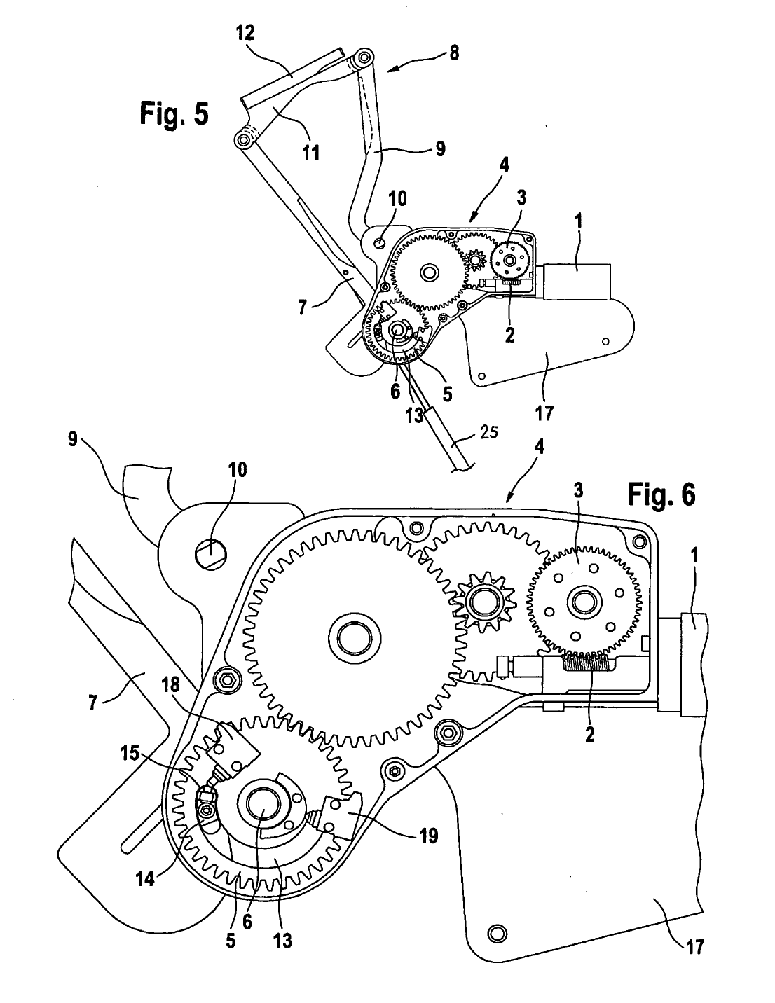

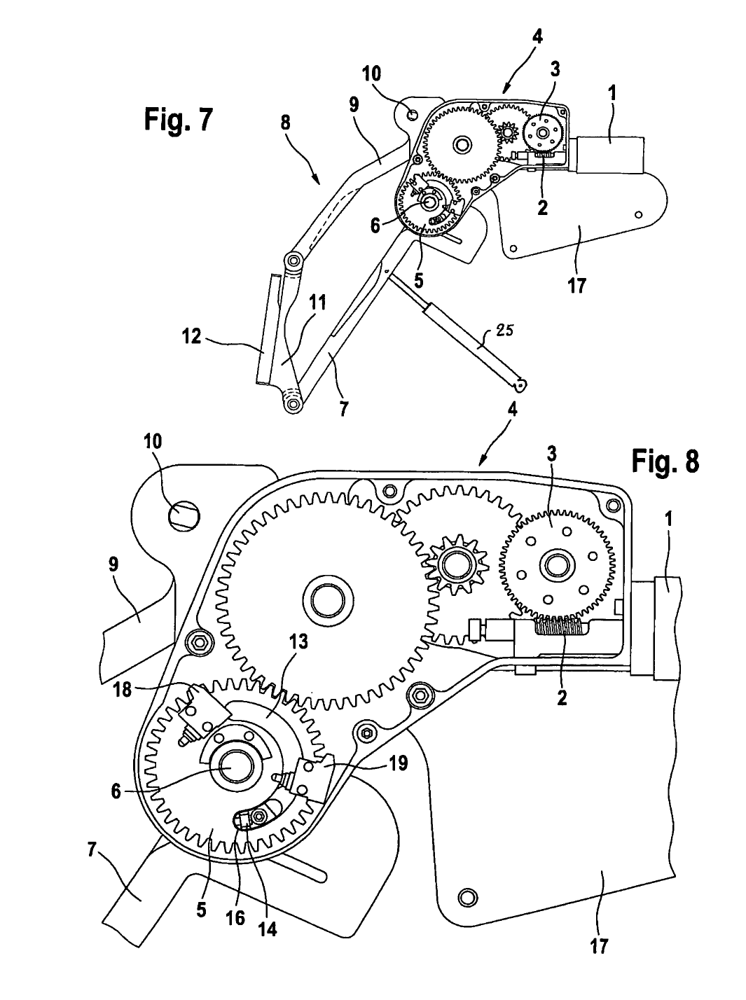

For motorized closing, the electromotor 1 is switched on, which drives the crank gear 5 anticlockwise, so that the first stop 15 drives the driving element 14 and the four bar linkage 8 anticlockwise (FIGS. 7 and 8). If a specific angle is passed in the closing direction, the flap 12 closes automatically, due to its inherent weight, against the force of the pneumatic spring.

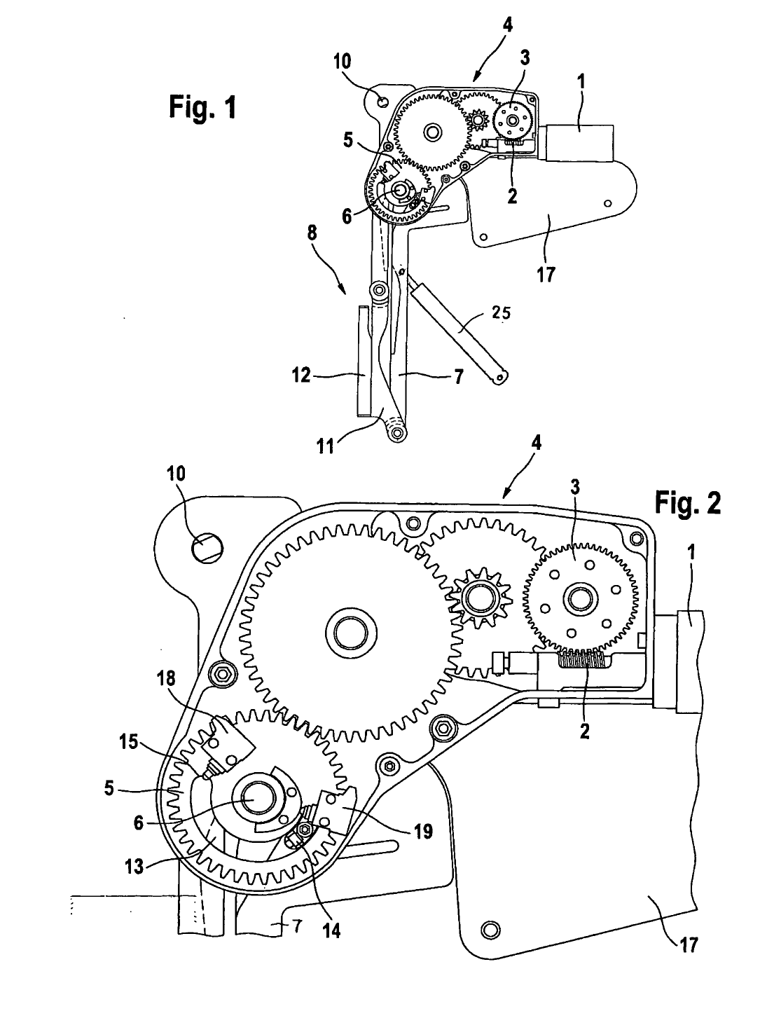

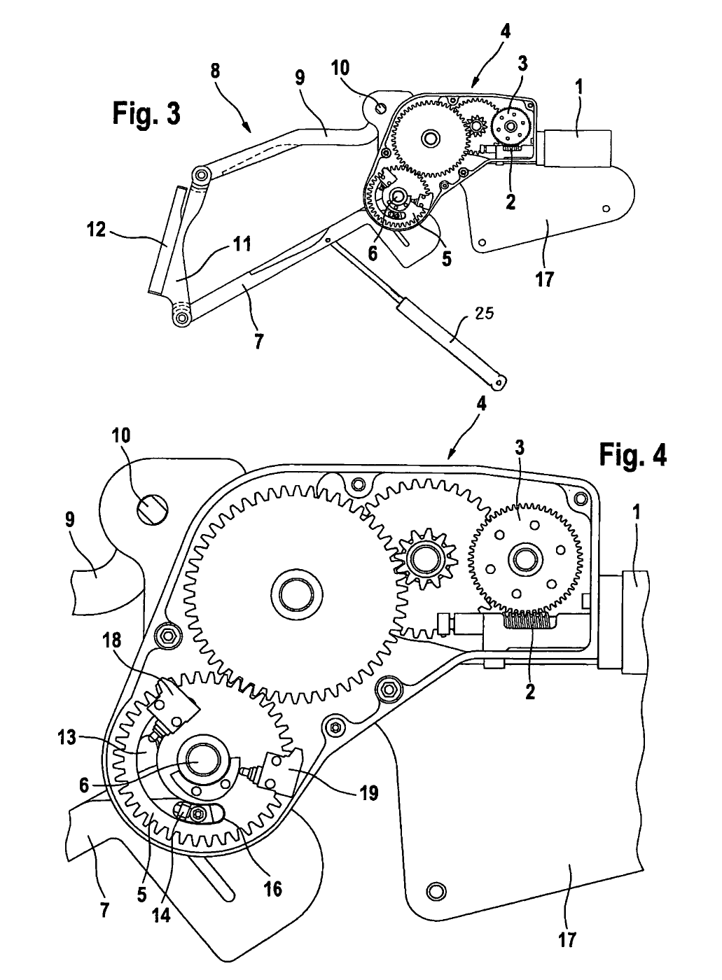

By means of the electromotor 1, the crank gear 5 is then moved again as far as its normal position as is shown in FIGS. 1 and 2.

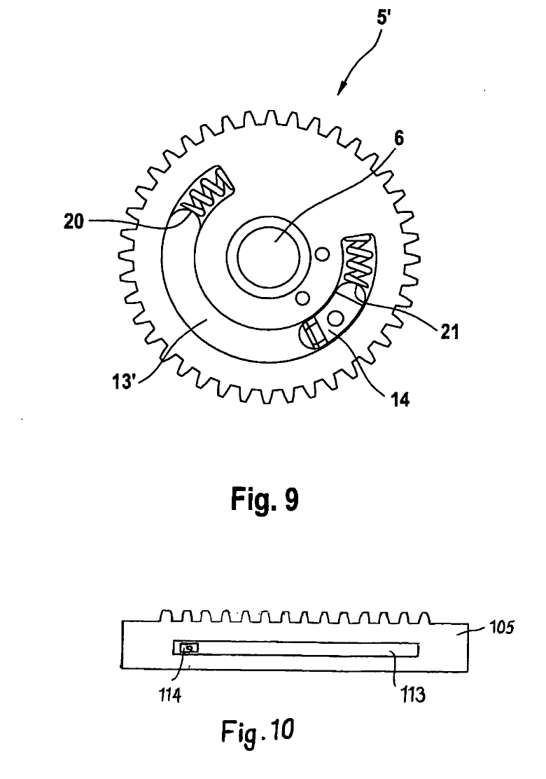

A further embodiment of a crank gear 5′ is shown in FIG. 9, in which a first spring stop 20 and a second spring stop 21 are arranged in the ends of the crank recess 13′. These spring stops 20 and 21 may be compressed when a set force applied by the driving element 14 is exceeded, whereby a switch signal is generated by switches, not shown, which results in the electromotor 1 being switched off. Alternatively, if an increased power consumption of the motor is identified, this may result in such a switching-off of the motor. This, however, only occurs with increased adjustment resistance as is, for example, provided in the event of manual intervention in the motorized adjustment motion of the flap 12. A normal motorized actuating drive does not result in any compression of the spring stops 20 and 21 or any triggering of a switch signal.

FIG. 10 shows a crank component 105 that is drivable in a linear movement between a normal position and an open position. The crank recess 113 extends in a straight line and engages a driving element 114.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An actuating device for moving a movable component, comprising:
a movable component movable from a normal position to an open position;
a driving element connected to said movable component;
a reversible motorized drive, wherein said driving element is drivable by said motorized drive for moving said movable component from the normal position to said open position, said motorized drive having a drive component defining a crank recess engaging said driving element, said crank recess extending along a path of motion of said driving element and having a length corresponding to a motion of the movable component between the normal position and a partially open or the open position;
a free wheel mechanism allowing the driving element to be uncoupled from said motorized drive in the open position; and
a switching device operatively arranged so that after said movable component has reached the open position said driving element is drivable by said motorized drive back to said normal position.

2. The actuating device of claim 1, wherein said switching device comprises at least one switching element configured to detect when the driving element has reached at least one end of said crank recess.

3. The actuating device of claim 1, wherein at least one end of said crank recess forms a stop against which said driving element bears during driving of said driving element by said motorized drive.

4. The actuating device of claim 3, wherein said stop comprises a spring stop which is deflected counter to a spring force when impinged upon by said driving element, said spring force being greater than the force applied by said driving element when said driving element is driven by said motorized drive and, wherein deflection of said spring stop by said driving element causes said switching device to identify the deflection by one of a switch signal being actuated or an increased power consumption of the motor, said switching device being configured to switch off said motorized drive when the deflection is identified by said switching device.

5. The actuating device of claim 1, wherein said motorized drive is a linear drive or a rotary drive.

6. The actuating device of claim 1, further comprising a gear mechanism, wherein said motorized drive is configured to drive said driving element through said gear mechanism.

7. The actuating device of claim 1, wherein said motorized drive is an electromotor.

8. The actuating device of claim 1, further comprising a spring applying a force urging said movable component in the direction of motion from the normal position into the open position.

9. The actuating device of claim 8, wherein said spring comprises a pneumatic spring.

10. The actuating device of claim 1, wherein said movable component is or carries a flap which closes an opening.

11. The actuating device of claim 10, wherein said flap is movably drivable from a vertical normal position into a raised open position.

12. The actuating device of claim 1, wherein the movable component is movably drivable in a linear manner between the normal position and the open position and said crank recess extends in a straight line.

13. The actuating device of claim 1, wherein said movable component is rotatable about a rotational axis between the normal position and the open position and said crank recess extends in a circular arc shape.

14. The actuating device of claim 13, wherein said free wheel mechanism comprises a drive wheel defining said crank recess, said drive wheel being rotatably mounted about said rotational axis and rotatably drivable by said motorized drive.

15. The actuating device of claim 13, wherein said movable component is a lever arm.

16. The actuating device of claim 15, wherein said lever arm is one arm of a four bar linkage.

17. The actuating device of claim 16, further comprising said four bar linkage including said lever arm, a link rod pivotable with one end about a second rotational axis parallel to said rotational axis, and a connecting rod coupled to free ends of said lever arm and said link rod.

18. The actuating device of claim 17, further comprising a flap which closes an opening, said flap being fixedly arranged on said connecting rod.

19. An actuating device for moving a movable component, comprising:
a movable component movable from a normal position to an open position;
a driving element connected to said movable component;
a reversible motorized drive;
a crank component drivable by said motorized drive for moving said movable component from the normal position to said open position and defining a crank recess engaging said driving element, said crank recess extending along a path of motion of said driving element and having a length corresponding to a motion of the movable component between the normal position and a partially open or the open position;
a free wheel mechanism, said free wheel mechanism allowing the driving element to be uncoupled from said motorized drive in the open position; and
a switching device operatively arranged so that after said movable component has reached the open position said driving element is drivable by said motorized drive back to said normal position.

20. The actuating device of claim 1, wherein said movable component is movably drivable by the reversible motorized drive through said crank component from the open position into the normal position and wherein said crank component is driven by said motorized drive into the normal position in response to said switching device after said movable component into its normal position.

21. The actuating device of claim 19, wherein said switching device comprises at least one switching element which detects when said driving element has reached an end of said crank recess.

22. The actuating device of claim 19, wherein at least one end of said crank recess forms a stop against which said driving element bears during driving of said driving element by said motorized drive.

23. The actuating device of claim 22, wherein said stop comprises a spring stop which is deflected counter to a spring force when impinged upon by said. driving element, said spring force being greater than the force applied by said driving element when said driving element is driven by said motorized drive and, wherein deflection of said spring stop by said driving element causes said switching device to identify the deflection by one of a switch signal being actuated or an increased power consumption of the motor, said switching device being configured to switch off said motorized drive when the deflection is identified by said switching device.

24. The actuating device of claim 19, wherein said motorized drive is a linear drive or a rotary drive.

25. The actuating device of claim 19, further comprising a gear mechanism, wherein said motorized drive is configured to drive said crank component through said gear mechanism.

26. The actuating device of claim 19, wherein said motorized drive is an electromotor.

27. The actuating device of claim 19, further comprising a spring applying a force urging said movable component in the direction of motion from the normal position into the open position.

28. The actuating device of claim 27, wherein said spring comprises a pneumatic spring.

29. The actuating device of claim 19, wherein said movable component is or carries a flap which closes an opening.

30. The actuating device of claim 29, wherein said flap is movably drivable from a vertical normal position into a raised open position.

31. The actuating device of claim 19, wherein the movable component is movably drivable in a linear manner between the normal position and the open position and said crank recess extends in a straight line.

32. The actuating device of claim 19, wherein said movable component is rotatable about a rotational axis between the normal position and the open position and said crank recess extends in a circular arc shape.

33. The actuating device of claim 32, wherein said crank component comprises a crank gear rotatably mounted about said rotational axis and rotatably drivable by said motorized drive.

34. The actuating device of claim 33, wherein said movable component is a lever arm.

35. The actuating device of claim 34, wherein said lever arm is one arm of a four bar linkage.

36. The actuating device of claim 35, further comprising said four bar linkage including said lever arm, a link rod pivotable with one end about a second rotational axis parallel to said rotational axis, and a connecting rod coupled to free ends of said lever arm and said link rod.

37. The actuating device of claim 36, further comprising a flap which closes an opening, said flap being fixedly arranged on said connecting rod.
